(19) United States
(12) Patent Application Publication
(10) Pub. No.: US 2021/0321801 A1
(43) Pub. Date: Oct. 21, 2021

(54) Heat Resistant Bowl Plate

(71) Applicant: Andrew Mikhael, New York, NY (US)

(72) Inventor: Andrew Mikhael, New York, NY (US)

(21) Appl. No.: 16/852,800

(22) Filed: Apr. 20, 2020

(51) Int. Cl. A47G 19/02; A47J 36/02; A47J 36/04; A47G 23/06

(52) U.S. Cl. CPC A47G 19/02; A47G 23/06; A47J 36/04; A47J 36/027

(57) ABSTRACT

A microwavable bowl plate system to support transporting hot kitchen bowls from underneath, preventing physical burns to skin. The size and curved center hole allows for various sized kitchen bowls to sit sturdy in the center top of the bowl plate while being used in household microwaves.

### BACKGROUND

It is traditional for hot foods such as soups or oatmeal to be prepared through a microwave and transported by hand through a common household bowl. The problem is most bowls do not have a system to be carried or held from preventing burns to the skin after cooking in high temperatures. Alternative solutions such as using traditional plates or napkins to support an extra layer for overheated bowls can be insufficient due to the thin material between physical contact and the bowl.

### SUMMARY

The present invention is directed to a bowl plate system, allowing users to safely lift and transport overheated bowls by providing a thick extra layer underneath the bowl, avoiding physical burns to skin.

The bowl plate of this invention can be used with circular-curved bowls as seen in common households. The bowl plate is a circular plate with an open curved circle through the middle. This allows various sized bowls to be placed on top of its center and easily transported by a user. The open center allows for air circulation, keeping the bowl plate at a cooler temperature when in contact with the overheated bowl. The diameter of the bowl plate is wide enough to fit in household microwaves while cooking for several minutes, resisting heat and supporting the bowl sitting on its top.

To transport the bowl plate, the user can simply lift up the outside-circular lip or carry from the curved underside for easier balance. The bowl is now sitting on top at a stable position allowing for easy transport. The bowl plate can be set back down on any flat surface with the bowl maintaining its stable position on top.

### FIGURE DESCRIPTIONS

FIG. 1 sequence diagram illustrating usage of the bowl plate system of this invention;

FIG. 2 shows a top view of the bowl plate.

FIG. 3 shows a sitting side view of the bowl plate.

### DESCRIPTION OF THE PREFERRED EMBODIMENT

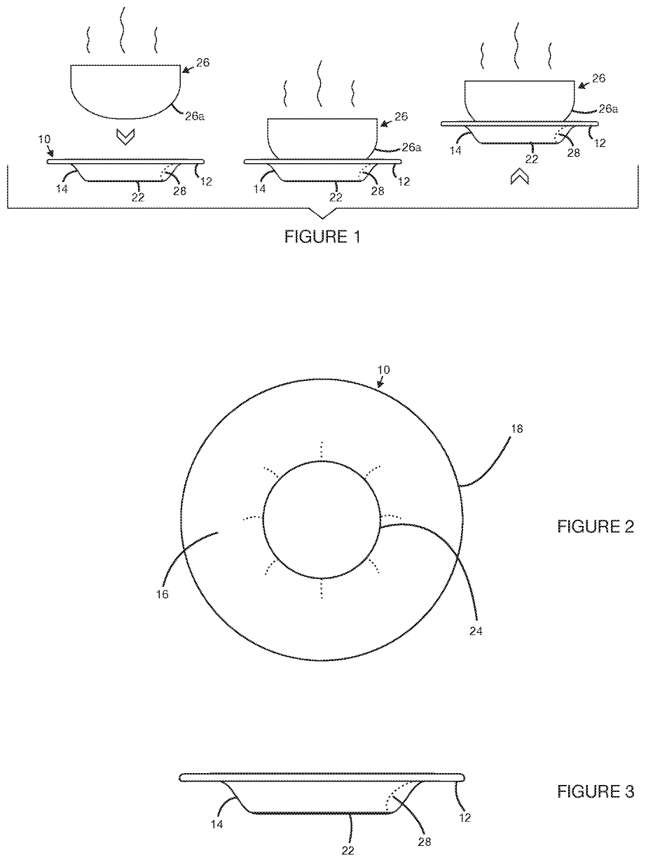

FIG. 1 illustrates each action in which a bowl plate [10] of this invention is used to lift and carry a hot bowl [26] from flat surfaces by a user's hand (not shown). When assembled as illustrated, the user may place both the bowl plate [10] and bowl [26] into a microwave oven to heat any foods or liquids inside the bowl and lift out when ready. This prevents unsafe physical contact from the surface of the overheated bowl [26a] after being lifted out of the microwave.

The diameter of the bowl plate [18] shown in FIG. 2 is wide enough to enter and sit inside household microwaves while cooking for several minutes with the bowl sitting on top of the bowl plate's center [24]. The curved in center hole [24] accommodates for various sized microwaveable bowls to sit in its center without exposing the hot bowl [26] from the underside [22] hole [24] of the bowl plate [10], allowing users to easily balance and transport the bowl [26] in a sturdy position. The contour [28] of the central hole [24] also allows for air to flow easily throughout the bowl plate [10], keeping the bowl plate at a cooler temperature when in contact with a hot bowl [26]. This center hole [24] is preferably made with a small diameter, preventing most household bowls not to fall through.

One of the two effective one-handed methods for the bowl plate [10] to be lifted is by grasping the lip [12] shown in FIG. 3 upwards when the bowl plate [10] is sitting on a flat surface on its bottom [22], keeping from contact with the hot bowl [26a]. The second most effective one-handed method continues off the first method by then placing the bottom flat side [22] of the bowl plate [10] at your palm to be easily transported without physical contact to the hot underside of a bowl [26a].

In most cases, it is best for the user to use both hands to lift the bowl plate [10] when transporting a hot bowl [26]. Depending on the weight and contents of the bowl [26], the user may prefer using the one-handed methods.

The bowl plate [10] is preferably made of a sturdy heat resistant plastic material, such as Polypropylene for its microwave-safe properties and easy to wash material, commonly used for microwaveable containers.

While this invention has been described in reference to the illustrations shown, it is not intended to be limited thereto. For example, the curvature [14] of the bowl plate [10] may change in thickness or the flat disc top [16] may utilize ribs for better grip and handling.

The embodiments of the invention in which an exclusive property or privilege is claimed are defined as follows:

1. In combination:
a heated bowl with a curved out circular structure from said base; and
a bowl plate system, allowing users to lift and transport overheated bowls by providing a thick extra layer underneath the bowl, avoiding direct contact to skin, a circular plate with an open curved circle through the middle allowing various sized bowls with a greater diameter than the bowl plate's center hole to be placed on top and transported by a user.

2. The combination of claim 1, where the bowl plate and bowl can be placed in household microwaves while in use for then safer transport after the bowl reaches high temperatures.

3. The combination of claim 1, where the bowl plate is generally circular in shape.

4. The combination of claim 2, where the bowl plate is formed of a microwave-safe plastic material.
